(19) United States
(12) Patent Application Publication
(10) Pub. No.: US 2025/0239114 A1
(43) Pub. Date: Jul. 24, 2025

(54) SYSTEMS AND METHODS FOR MANAGING VEHICLE EVENT DATA

(71) Applicant: TOYOTA JIDOSHA KABUSHIKI KAISHA, Toyota-shi (JP)

(72) Inventor: Caleb MCGARY, Tokyo (JP)

(73) Assignee: TOYOTA JIDOSHA KABUSHIKI KAISHA, Toyota-shi (JP)

(21) Appl. No.: 18/421,048

(22) Filed: Jan. 24, 2024

(51) Int. Cl. G07C 5/08; G07C 5/00

(52) U.S. Cl. CPC G07C 5/0816; G07C 5/008; G07C 5/0841

(57) ABSTRACT

Provided are a method, system, and device for managing vehicle event data for a vehicle. The method may be implemented by an Electronic Control Unit (ECU) of the vehicle and include determining that a vehicle event in an event log belongs to an unregistered event type; generating a temporary event identifier (ID) indicating characteristics of the vehicle event; storing the temporary event ID in a database with a timestamp; determining whether a number of vehicle events in the event log with the same temporary event ID exceed a predetermined threshold value; and based on determining that the number of vehicle events exceeds the predetermined threshold value, triggering a response for the vehicle associated with the temporary event ID.

### TECHNICAL FIELD

Systems and methods consistent with example embodiments of the present disclosure relate to providing a method for managing vehicle event data.

### BACKGROUND

In the related art, a vehicle, and in particularly, vehicle components (such as lights, brakes, sensors, etc.) may generate vehicle data. A subset of such vehicle data may be referred to as an event, which may be a short message that is sent to a log and/or other databases present in the vehicle or elsewhere. For instance, if a vehicle experiences a crash, an impact sensor may log a crash event, and this event may be packaged and sent (for example, to a cloud network). The vehicle may be configured to take action based on receiving certain events, since events may have pre-defined types as part of a standard. For example, if a crash event is received, the vehicle may be configured to automatically contact emergency services.

There arises an issue where vehicle components may log an unexpected event which is not predefined (e.g., it is not declared as part of a standard), and accordingly, such an event may be logged without being properly registered and no action may be taken on the event.

Accordingly, there is a need for a method which can handle registering unexpected/anomalous events and for handling responses for vehicle events.

### SUMMARY

According to one or more example embodiments, apparatuses and methods are provided for managing vehicle event data of a vehicle. In particular, apparatuses and methods according to example embodiments may be implemented by an Electronic Control Unit (ECU) of the vehicle and include determining that a vehicle event in an event log belongs to an unregistered event type; generating a temporary event identifier (ID) indicating characteristics of the vehicle event; storing the temporary event ID in a database with a timestamp; determining whether a number of vehicle events in the event log with the same temporary event ID exceed a predetermined threshold value; and based on determining that the number of vehicle events exceeds the predetermined threshold value, triggering a response for the vehicle associated with the temporary event ID.

Accordingly, anomaly detection for events which are not pre-defined (unregistered event type) as part of a standard may be accounted for, and appropriate responses may be taken for events which are not pre-defined, since the response is based on a threshold of receiving similar vehicle events.

According to embodiments, a method for managing vehicle event data performed by an electronic control unit (ECU) of a vehicle may be provided. The method may include: determining that a vehicle event in an event log belongs to an unregistered event type; generating a temporary event identifier (ID) based on at least one characteristic of the vehicle event; storing the temporary event ID in a database with a timestamp; determining whether a number of vehicle events in the event log with the temporary event ID exceed a predetermined threshold value; and based on determining that the number of vehicle events exceeds the predetermined threshold value, triggering a response for the vehicle associated with the temporary event ID.

The method may further include adding a new vehicle event received from a vehicle component of the vehicle to the event log; and determining whether the new vehicle event belongs to the unregistered event type based on the temporary event ID.

The method may include determining whether the new vehicle event belongs to the registered event type based on the temporary event ID is performed using a machine learning (ML) model.

Generating the temporary event ID may be based on a hash using at least one of a source vehicle component of the vehicle, distance of the source vehicle component from safety and security infrastructure in the vehicle, and a message in the vehicle event.

The method may further include adding a registered event type and a response for the vehicle associated with the registered event type to the database.

The predetermined threshold value and the response for the vehicle associated with the temporary event ID may be stored in the database.

Triggering the response for the vehicle may include sending a message to a cloud network.

According to embodiments, an apparatus for managing vehicle event data performed by an electronic control unit (ECU) of a vehicle may be provided. The apparatus may include: at least one memory storing computer-executable instructions; and at least one processor configured to execute the computer-executable instructions to: determine that a vehicle event in an event log belongs to an unregistered event type; generate a temporary event identifier (ID) based on at least one characteristic of the vehicle event; store the temporary event ID in a database with a timestamp; determine whether a number of vehicle events in the event log with the temporary event ID exceed a predetermined threshold value; and based on determining that the number of vehicle events exceeds the predetermined threshold value, trigger a response for the vehicle associated with the temporary event ID.

The at least one processor may be further configured to execute the computer-executable instructions to: add a new vehicle event received from a vehicle component of the vehicle to the event log; and determine whether the new vehicle event belongs to the unregistered event type based on the temporary event ID.

The at least one processor may be configured to determine whether the new vehicle event belongs to the registered event type based on the temporary event ID by using a machine learning (ML) model.

The at least one processor may be configured to generate the temporary event ID based on a hash using at least one of a source vehicle component of the vehicle, distance of the source vehicle component from safety and security infrastructure in the vehicle, and a message in the vehicle event.

The at least one processor may be further configured to execute the computer-executable instructions to: add a registered event type and a response for the vehicle associated with the registered event type to the database. The predetermined threshold value and the response for the vehicle associated with the temporary event ID may be stored in the database.

The at least one processor may be configured to trigger the response for the vehicle by sending a message to a cloud network.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects and advantages of certain exemplary embodiments of the disclosure will be described below with reference to the accompanying drawings, in which like reference numerals denote like elements, and wherein:

FIG. 1 illustrates a diagram of example components of a device, according to one or more embodiments;

FIG. 2 illustrates a diagram of examples components of a system for handling vehicle event data according to one or more example embodiments;

FIG. 3 is a flowchart diagram showing a vehicle event data management process for generating a temporary event identifier (ID) according to one or more example embodiments;

FIG. 4 is a flowchart diagram showing a vehicle event data management process for adding a new vehicle event to the event log according to one or more example embodiments; and

FIG. 5 is a flowchart diagram showing a vehicle event data management process for handling receiving a plurality of messages from a plurality of vehicle components and triggering a vehicle response according to one or more example embodiments.

### DETAILED DESCRIPTION

The following detailed description of example embodiments refers to the accompanying drawings. The disclosure provides illustration and description, but is not intended to be exhaustive or to limit one or more example embodiments to the precise form disclosed. Modifications and variations are possible in light of the disclosure or may be acquired from practice of one or more example embodiments. Further, one or more features or components of one example embodiment may be incorporated into or combined with another example embodiment (or one or more features of another example embodiment). Additionally, in the flowcharts and descriptions of operations provided herein, it is understood that one or more operations may be omitted, one or more operations may be added, one or more operations may be performed simultaneously (at least in part), and the order of one or more operations may be switched.

It will be apparent that example embodiments of systems and/or methods and/or non-transitory computer readable storage mediums described herein may be implemented in different forms of hardware, firmware, or a combination of hardware and software. The actual specialized control hardware or software code used to implement these systems and/or methods is not limiting of one or more example embodiments. Thus, the operation and behavior of the systems and/or methods and/or non-transitory computer readable storage mediums are described herein without reference to specific software code. It is understood that software and hardware may be designed to implement the systems and/or methods based on the descriptions herein.

Even though particular combinations of features are recited in the claims and/or disclosed in the specification, these combinations are not intended to limit the disclosure of possible example embodiments. In fact, many of these features may be combined in ways not specifically recited in the claims and/or disclosed in the specification. Although each dependent claim listed below may directly depend on only one claim, the disclosure of possible example embodiments includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

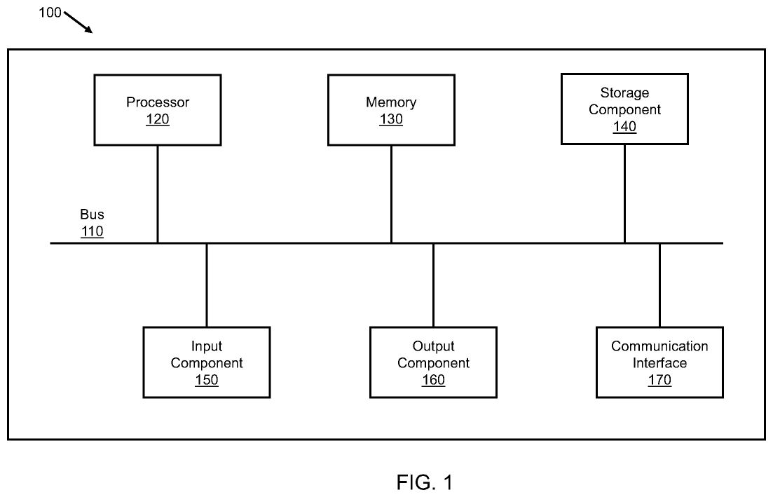

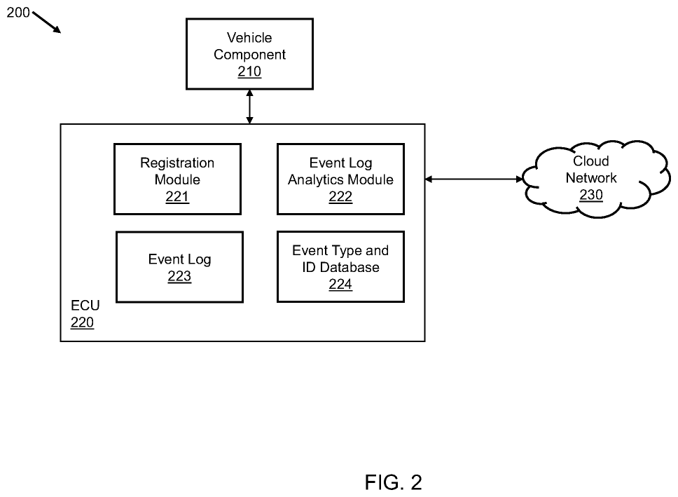

FIG. 1 illustrates a diagram of example components of a device 100, according to one or more embodiments. Device 100 may be used to implement ECU 220 described with respect to FIG. 2 (as discussed below).

Referring to FIG. 1, device 100 may include a bus 110, a processor 120, a memory 130, a storage component 140, an input component 150, an output component 160, and a communication interface 170.

Bus 110 may include one or more components that permit communication among the components of device 100. Processor 120 may be implemented in hardware, firmware, or a combination of hardware and software. Processor 120 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing or computing component. In some implementations, processor 120 may include one or more processors capable of being programmed to perform a function. Memory 130 may include a random access memory (RAM), a read only memory (ROM), and/or another type of dynamic or static storage device (e.g., a flash memory, a magnetic memory, and/or an optical memory) that stores information and/or instructions for use by processor 120.

Storage component 140 may store information and/or software related to the operation and use of device 100. For example, storage component 140 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 150 may include one or more components that permit device 100 to receive information, such as via user input (e.g., a touch screen display, a keyboard, a keypad, a mouse, a button, a switch, and/or a microphone). Additionally, or alternatively, input component 150 may include a sensor for sensing information (e.g., a global positioning system (GPS) component, an accelerometer, a gyroscope, and/or an actuator). Output component 160 may include one or more components that provide output information from device 100 (e.g., a display, a speaker, and/or one or more light-emitting diodes (LEDs)).

Communication interface 170 may include a transceiver-like component (e.g., a transceiver and/or a separate receiver and transmitter) that enables device 100 to communicate with other devices, such as via a wired connection, a wireless connection, or a combination of wired and wireless connections. Communication interface 170 may permit device 100 to receive information from another device (e.g., device included in the plurality of vehicles, etc.) and/or provide information to said another device. For example, communication interface 170 may include an Ethernet interface, an optical interface, a coaxial interface, an infrared interface, a radio frequency (RF) interface, a universal serial bus (USB) interface, a Wi-Fi interface, a cellular network interface, or the like.

Device 100 may perform one or more processes described herein in response to processor 120 executing software instructions stored by a non-transitory computer-readable medium, such as memory 130 and/or storage component 140. A computer-readable medium is defined herein as a non-transitory memory device. A memory device includes memory space within a single physical storage device or memory space spread across multiple physical storage devices.

Software instructions may be read into memory 130 and/or storage component 140 from another computer-readable medium or from another device via communication interface 170. When executed, software instructions stored in memory 130 and/or storage component 140 may cause processor 120 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

FIG. 2 is a diagram of examples components of a system 200 for handling vehicle event data according to one or more example embodiments. Vehicle component 210, Electronic Control Unit (ECU) 220, and cloud network 230 may be provided. ECU 220 may comprise registration module 221, event log analytics module 222, event log 223, and event type and ID database 224. Vehicle component 210 may be any component in a vehicle which can implement a function. For example, the vehicle component 210 may include, but may not be limited to, lights, brakes, and sensors. It should be appreciated that each individual vehicle component may have its own corresponding ECU, or all the individual vehicle components may share one central ECU, depending on the specific implementation.

Registration module 221 may allow for functions of vehicle components 210 to register their own event types into event type and ID database 224, along with a potential response for such events. According to embodiments, this may include a user interface (such as a GUI) to allow for the manufacturer to define a new event type and potential response for the associated event type. During build time, registration module 221 may perform an audit in order to search for functions which are registering a safety relevant response (e.g., which may involve the safety of the operator of the vehicle). According to embodiments, a new event type may be registered using a standard (for instance, ISO 19770-3).

Event log analytics module 222 may be a software component which can analyze anomalies of event log 223. According to embodiments, event log analytics module 222 may be configured to determine characteristics of events in the event log 223, and record them into event type and ID database 224. Characteristics may include, but are not limited to, the rate of occurrence of a certain type of event (number of occurrences overall and number of occurrences over a defined time slot), location of the source vehicle component with regards to placement of safety critical infrastructure in the vehicle, location of the source vehicle component with regards to placement of security critical infrastructure in the vehicle, the specific geolocation of where the event occurred, and the vehicle state (stopped, started, moving, charging, etc.). For example, a safety critical infrastructure may be related to the safety of the user (e.g., to ensure safe operability of the vehicle for the user), and a security critical infrastructure may be related to the security of the vehicle (e.g., against vehicle theft). Event log analytics module 222 may be configured to use the characteristics to determine that a specific vehicle event or a plurality of vehicle events belong to an unregistered event type.

Event log analytics module 222 may be configured to generate temporary event identifiers (ID) for unregistered event types. In particular, event log analytics module 222 may be used to evaluate the event log 223 for any vehicle events which are considered as belonging to an unregistered event type, and ingest such events to generate a raw hash which can be used as a temporary event ID. The temporary event ID may be based on the source of the event (e.g., which vehicle component it is from), distance from safety and security infrastructure in the vehicle, and the event message. For example, a hashing algorithm function may generate the hash value (i.e., temporary event ID or at least a portion of the temporary event ID) by using (or inputting) at least one of the source of the event, distance from safety and security infrastructure in the vehicle, and event message.

According to embodiments, the temporary event ID may be stored in event type and ID database 224 with a timestamp, and when any other similar event (e.g., a same event, an event with at least a threshold number of common predetermined event parameters or characteristics, an event included within a predetermined grouping of events, etc.) is received, the same temporary event ID or a similar temporary event ID (e.g., generated by the hash algorithm) may be stored in event type and ID database 224.

According to embodiments, event log analytics module 222 may also be configured to check, when (or based on) a new event is added to event log 223, to see if there are prior (or older) events of the same type in event log 223 based at least in part on the temporary event ID. The event log analytics module 222 may determine prior events as being of the same (or similar) type by using a machine learning (ML) model and/or by determining whether the temporary event IDs have at least a predetermined degree of similarity or overlap, for example, based on determined characteristics of events in event log 223.

According to embodiments, event log analytics module 222 may delete or instruct event log 223 to delete at least one prior event based on a determination with respect to a storage threshold (e.g., a predetermined period or length of time, a predetermined number of events, etc.). For example, if the prior event(s) is older than the storage threshold (e.g., a predetermined period or length of time), the event log analytics module 222 may instruct event log 223 to delete the prior event. By way of another example, if the number of prior events of the same type in event log 223 exceeds the storage threshold (e.g., a predetermined number of events), the event log analytics module 222 may instruct event log 223 to delete the oldest prior event.

Event log analytics module 222 may implement a machine learning (ML) model in order to perform the analytics, according to embodiments. Analytics may be performed as to determine whether or not the number of vehicle events of a certain type (for example, sharing the same temporary event ID) exceed a threshold. The threshold may be defined by the vehicle vendor (e.g., original equipment manufacturer OEM), and stored in event type and ID database 224. If the threshold is exceeded, a response may be triggered, for example, event logs 223 may be collected, signed, and transmitted to cloud network 230. In addition, if the events are anomalies which are near security/safety critical infrastructure a response may be sent to a vehicle component 210 (e.g., illuminating a check engine light). For example, a threshold which may be defined is a number of events of an unregistered event type (or sharing the same temporary event ID) exceeding a predetermined threshold value. Alternatively, a threshold which may be defined is a number of events which are anomalies (of an unregistered event type) near security/safety critical infrastructure exceed a pre-defined threshold value. It should be appreciated by one skilled in the art that the defined thresholds and responses for the event log analytics module 222 may depend on the specific implementation.

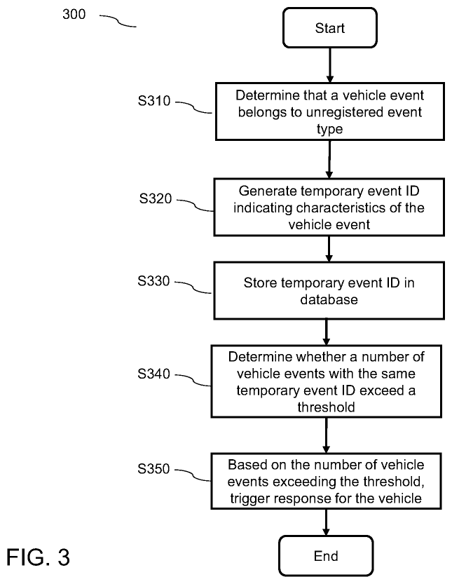

FIG. 3 illustrates an example flowchart showing a vehicle event data management process 300 for generating a temporary event identifier (ID), according to embodiments. Process 300 may be implemented using system 200 in FIG. 2 above, particularly, using ECU 220.

At operation 310, a vehicle event in an event log (such as event log 223) may be determined as to whether it belongs to an unregistered event type. According to embodiments, determining may be based on detecting that the vehicle event does not belong to any registered event type. Additionally or alternatively, determining may be based on analyzing characteristics in the event log (for example, the rate of occurrence of a certain type of event (number of occurrences overall and number of occurrences over a defined time slot), location of the source vehicle component with regards to placement of safety critical infrastructure in the vehicle, location of the source vehicle component with regards to placement of security critical infrastructure in the vehicle, the specific geolocation of where the event occurred, and the vehicle state (stopped, started, moving, charging, etc.)

At operation 320, a temporary event ID may be generated, which may indicate characteristics of the vehicle event. According to embodiments, this may be generated based on a hashing function with characteristics of the vehicle event as an input. The characteristics may include at least one of a source vehicle component of the vehicle, distance of the source vehicle component from safety and security infrastructure in the vehicle, and a message in the vehicle event.

At operation 330, the temporary event ID may be stored in a database with a timestamp. For example, this may be a database such as event type and ID database 224 described with respect to FIG. 2 above.

At operation 340, it may be determined as to whether a number of vehicle events in the event log with the same temporary event ID exceed a predefined threshold value. In particular, this predefined threshold value may be a number of events, and may be stored in a database (such as event type and ID database 224).

At operation 350, based on determining that the number of vehicle events exceed the predefined threshold value (based on the determination in operation 340), a response may be triggered for the vehicle which are associated with the particular temporary event ID. The response may be previously stored in a database (event type and ID database 224) to be associated with the temporary event ID.

For example, if there were three events related to messages for failing to start the vehicle, and the predefined threshold value is two, the appropriate trigger which is stored in the database may be executed (e.g., a vehicle lockout). This may be in order to prevent vehicle theft, in the case the events are interpreted as being security relevant. Alternatively, if the events are safety relevant, a safety relevant response may be taken. According to embodiments, the response may include sending and/or signing the data to the cloud network (e.g., cloud network 230). The cloud network may take actions, such as performing analysis, recognizing a pattern of the data, and taking a further action, such as contacting emergency services. Nevertheless, it should be appreciated by a person skilled in the art that the specific response may depend on the particular implementation.

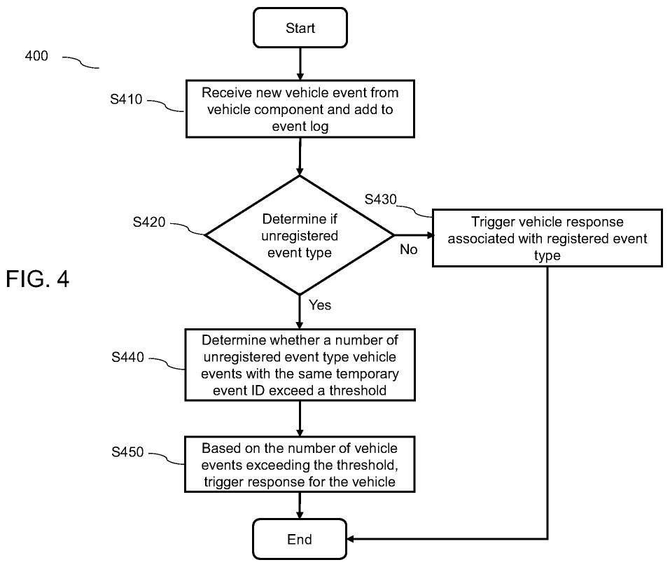

FIG. 4 is a flowchart diagram showing a vehicle event data management process 400 for adding a new vehicle event to the event log according to one or more example embodiments. Process 400 may be implemented using system 200 in FIG. 2 above, particularly, using ECU 220.

At operation 410, a new vehicle event may be received from a vehicle component (e.g., vehicle component 210) of the vehicle, and added to an event log (e.g., event log 223). For example, this may be an event received from a front driver-side light. According to some embodiments, a message may firstly be received from the vehicle component, and subsequently entered as an event into the event log (the event may include further data aside from what was received from the vehicle component as a message).

At operation 420, it may be determined as to whether the new vehicle event which was added to the event log belongs to an unregistered event type. This may firstly include checking whether the new vehicle event belongs to any pre-defined registered event type based on analysis with reference to event type and ID database 224 (if it belongs to the pre-defined registered event type, no further determination may be required). Determining may also include analyzing whether the new vehicle event matches/corresponds to a temporary event ID located in event type and ID database, and based on determining that it matches/corresponds, concluding that it is an unregistered event type. If the new vehicle event does not match with any existing temporary event ID, the analysis may still conclude that it is an unregistered event type, and generate a new temporary event ID which indicates characteristics of the vehicle event. This may be similar to operations 310 and 320 with reference to FIG. 3 above.

At operation 430, if it was determined in operation 420 that the new vehicle event added to the event log is not an unregistered event type (e.g., it is a registered event type), the ECU may trigger the vehicle response associated with the registered event type. The vehicle response and the associated registered event type may be already defined in event type and ID database 224 by registration module 221, and accordingly, the response may be triggered based on checking the corresponding vehicle response in event type and ID database 224. For example, a seat weight sensor event which occurs when a passenger seat detects an amount of weight exceeding a threshold but the seatbelt is unfastened may be defined as a registered event type, and the ECU may check for an associated vehicle response which may be pre-defined as turning on a seatbelt indicator light (which indicates for the passenger to fasten their seatbelt), and execute the associated vehicle response.

At operation 440, if it was determined in operation 420 that the new vehicle event type added to the event log is an unregistered event type, the ECU may determine whether a number of unregistered type vehicle events with a same temporary ID as the new vehicle event exceed a threshold value defined as a number of vehicle events. This may be similar to operation 340 described with reference to FIG. 3 above.

At operation 450, if it was determined in operation 440 that the number of vehicle events exceed the predetermined threshold value, a response associated with the temporary ID may be triggered for the vehicle. This may be similar to operation 350 described with reference to FIG. 3 above.

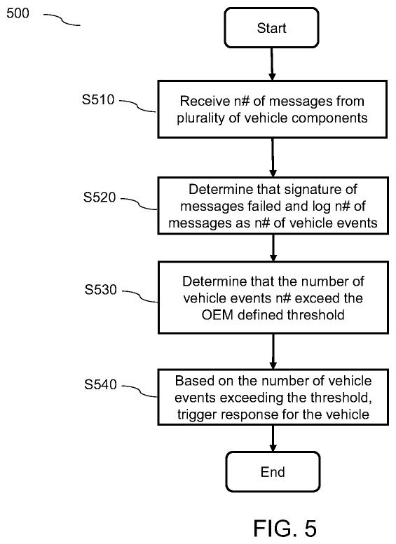

FIG. 5 is a flowchart diagram showing a vehicle event data management process 500 for handling receiving a plurality of messages from a plurality of vehicle components and triggering a vehicle response according to one or more example embodiments.

At operation 510, a number of messages n # may be received from a plurality of vehicle components. Particularly, these messages may be received from different vehicle lights that are trying to start the vehicle (this may indicate that an attempt to start the vehicle has failed). The messages may be security relevant and are normally signed. For example, one message may be from the front driver's side light, and the another two may be from the front passenger side light, for a total of three messages. It should be appreciated that messages may be received from other groupings of vehicle components (i.e., a driver side seat sensor and a passenger side seat sensor) may be used to receive messages from, depending on the specific scenario.

At operation 520, it may be determined that the signature of the messages received in operation 510 are failed or anomalous. Accordingly, the ECU may log an n # of vehicle events corresponding to each message received in operation 510 into the event log. In this case, the vehicle events may be determined as belonging to an unregistered event type, since the signature of the message failed. Accordingly, it should be appreciated that a temporary event ID may be generated, or may already exist for the unregistered event type. While logging the events, the ECU may consider that the vehicle components are roughly equidistant from the ECU, and the location with regards to safety critical infrastructure within the vehicle is the same. Accordingly, on this basis, the ECU may consider that each of the n # of vehicle events belong to the same unregistered event type during logging. Based on the example discussed in operation 510 with respect to receiving a message from the front driver side light and two from the front passenger side light, a total of three vehicle events may be added to the event log corresponding to each message.

At operation 530, the number of vehicle events n # which were logged in operation 520 may be determined as exceeding a predefined OEM defined threshold (which may be predefined in an event type and ID database 224). For example, if the predefined OEM threshold is set at two events, the three events which are logged with respect to the example discussed in operation 520 may be considered as exceeding the predefined OEM threshold.

At operation 540, if it was determined in operation 530 that the number of vehicle events n # exceeds the predefined OEM defined threshold, an associated response for the vehicle may be triggered. This may be an OEM defined response (which may be predefined in an event type and ID database 224). For example, upon receiving more than two events, the OEM defined response may be to prevent the vehicle from starting for a period of times (e.g., 4 hours). This may be with respect to a security related event, in order to prevent a thief from stealing the vehicle. The ECU may accordingly convey to some other component in the vehicle (such as a Data Communication Module (DCM)) that the vehicle has entered a lockdown state, and collect the event logs, sign the event logs, and send them off-vehicle (for example, to a cloud network 230) for analysis. The event logs may be analyzed to determine that a pattern thereof matches with a common car their tactic, and law enforcement and/or emergency services may be contacted. Nevertheless, the specific OEM defined response may depend on the specific implementation, as determined by the vendor.

Based on the above embodiments, it can be understood that anomaly detection for events which are not pre-defined (unregistered event type) as part of a standard may be accounted for, and appropriate responses may be taken for events which are not pre-defined, since the response is based on a threshold of receiving similar vehicle events.

The foregoing disclosure provides illustration and description, but is not intended to be exhaustive or to limit one or more example embodiments to the precise form disclosed. Modifications and variations are possible in light of the disclosure or may be acquired from practice of one or more example embodiments.

One or more example embodiments may relate to a system, a method, and/or a computer readable medium at any possible technical detail level of integration. Further, one or more of the components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In one or more example embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible example embodiments of systems, methods, and computer readable media according to one or more example embodiments. In this regard, each block in the flowchart or block diagrams may represent a microservice(s), module, segment, or portion of instructions, which comprises one or more executable instructions for implementing the specified logical function(s). The method, computer system, and computer readable medium may include additional blocks, fewer blocks, different blocks, or differently arranged blocks than those depicted in the drawings. In one or more alternative example embodiments, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of one or more example embodiments. Thus, the operation and behavior of the systems and/or methods were described herein without reference to specific software code—it being understood that software and hardware may be designed to implement the systems and/or methods based on the description herein.

What is claimed is:

1. A method for managing vehicle event data performed by an electronic control unit (ECU) of a vehicle, the method comprising:
determining that a vehicle event in an event log belongs to an unregistered event type;
generating a temporary event identifier (ID) based on at least one characteristic of the vehicle event;
storing the temporary event ID in a database with a timestamp;
determining whether a number of vehicle events in the event log with the temporary event ID exceed a predetermined threshold value; and
based on determining that the number of vehicle events exceeds the predetermined threshold value, triggering a response for the vehicle associated with the temporary event ID.

2. The method of claim 1, further comprising:
adding a new vehicle event received from a vehicle component of the vehicle to the event log; and
determining whether the new vehicle event belongs to the unregistered event type based on the temporary event ID.

3. The method of claim 2, wherein determining whether the new vehicle event belongs to the registered event type based on the temporary event ID is performed using a machine learning (ML) model.

4. The method of claim 1, wherein generating the temporary event ID is based on a hash using at least one of a source vehicle component of the vehicle, distance of the source vehicle component from safety and security infrastructure in the vehicle, and a message in the vehicle event.

5. The method of claim 1, further comprising:
adding a registered event type and a response for the vehicle associated with the registered event type to the database.

6. The method of claim 1, wherein the predetermined threshold value and the response for the vehicle associated with the temporary event ID are stored in the database.

7. The method of claim 1, wherein the triggering the response for the vehicle comprises sending a message to a cloud network.

8. An apparatus for managing vehicle event data performed by an electronic control unit (ECU) of a vehicle, the apparatus comprising:
at least one memory storing computer-executable instructions; and
at least one processor configured to execute the computer-executable instructions to:
determine that a vehicle event in an event log belongs to an unregistered event type;
generate a temporary event identifier (ID) based on at least one characteristic of the vehicle event;
store the temporary event ID in a database with a timestamp;
determine whether a number of vehicle events in the event log with the temporary event ID exceed a predetermined threshold value; and
based on determining that the number of vehicle events exceeds the predetermined threshold value, trigger a response for the vehicle associated with the temporary event ID.

9. The apparatus of claim 8, wherein the at least one processor is further configured to execute the computer-executable instructions to:
add a new vehicle event received from a vehicle component of the vehicle to the event log; and
determine whether the new vehicle event belongs to the unregistered event type based on the temporary event ID.

10. The apparatus of claim 9, wherein the at least one processor is configured to determine whether the new vehicle event belongs to the registered event type based on the temporary event ID by using a machine learning (ML) model.

11. The apparatus of claim 8, wherein the at least one processor is configured to generate the temporary event ID based on a hash using at least one of a source vehicle component of the vehicle, distance of the source vehicle component from safety and security infrastructure in the vehicle, and a message in the vehicle event.

12. The apparatus of claim 8, wherein the at least one processor is further configured to execute the computer-executable instructions to:
add a registered event type and a response for the vehicle associated with the registered event type to the database.

13. The apparatus of claim 8, wherein the predetermined threshold value and the response for the vehicle associated with the temporary event ID are stored in the database.

14. The apparatus of claim 8, wherein the at least one processor is configured to trigger the response for the vehicle by sending a message to a cloud network.

15. A non-transitory computer-readable recording medium having recorded thereon instructions to perform a method for managing vehicle event data performed by an electronic control unit (ECU) of a vehicle, the method comprising:
determining that a vehicle event in an event log belongs to an unregistered event type;
generating a temporary event identifier (ID) based on at least one characteristic of the vehicle event;
storing the temporary event ID in a database with a timestamp;
determining whether a number of vehicle events in the event log with the temporary event ID exceed a predetermined threshold value; and
based on determining that the number of vehicle events exceeds the predetermined threshold value, triggering a response for the vehicle associated with the temporary event ID.

16. The non-transitory computer-readable recording medium of claim 15, the method further comprising:
adding a new vehicle event received from a vehicle component of the vehicle to the event log; and
determining whether the new vehicle event belongs to the unregistered event type based on the temporary event ID.

17. The non-transitory computer-readable recording medium of claim 16, wherein determining whether the new vehicle event belongs to the registered event type based on the temporary event ID is performed using a machine learning (ML) model.

18. The non-transitory computer-readable recording medium of claim 15, wherein generating the temporary event ID is based on a hash using at least one of a source vehicle component of the vehicle, distance of the source vehicle component from safety and security infrastructure in the vehicle, and a message in the vehicle event.

19. The non-transitory computer-readable recording medium of claim 15, the method further comprising:
adding a registered event type and a response for the vehicle associated with the registered event type to the database.

20. The non-transitory computer-readable recording medium of claim 15, wherein the predetermined threshold value and the response for the vehicle associated with the temporary event ID are stored in the database.
